(19) United States
(12) Patent Application Publication
(10) Pub. No.: US 2023/0264424 A1
(43) Pub. Date: Aug. 24, 2023

(54) THREE-DIMENSIONAL MOLDING DEVICE

(71) Applicant: SEIKO EPSON CORPORATION, Tokyo (JP)

(72) Inventor: Katsutoshi MATSUURA, Chino (JP)

(21) Appl. No.: 18/169,906

(22) Filed: Feb. 16, 2023

(30) Foreign Application Priority Data
Feb. 18, 2022 (JP) 2022-023729

(51) Int. Cl. B29C 64/393; B33Y 50/02; B29C 64/118; B29C 64/295; B29C 64/25; B33Y 30/00; B29C 64/364; G05B 19/4099

(52) U.S. Cl. CPC B29C 64/393; B33Y 50/02; B29C 64/118; B29C 64/295; B29C 64/25; B33Y 30/00; B29C 64/364; G05B 19/4099; G05B 2219/49023

(57) ABSTRACT

A three-dimensional molding device includes: an ejection unit including a plasticization unit that plasticizes a material to generate a molding material, and configured to eject the molding material from a nozzle opening; a stage configured to support the molding material ejected from the ejection unit; a heating unit configured to heat the molding material deposited on the stage; a position changing unit configured to change relative positions of the ejection unit and the stage; a housing configured to accommodate the ejection unit, the stage, the heating unit, and the position changing unit, and including a door; a lock mechanism configured to lock and unlock the door; a temperature detection unit configured to detect a temperature of at least one of the plasticization unit, the stage, and the heating unit; and a control unit. The control unit controls the lock mechanism based on a detection result of the temperature detection unit.

The present application is based on, and claims priority from JP Application Serial Number 2022-023729, filed on Feb. 18, 2022, the disclosure of which is hereby incorporated by reference herein in its entirety.

### BACKGROUND

### 1. Technical Field

The present disclosure relates to a three-dimensional molding device.

### 2. Related Art

There is known a three-dimensional molding device that molds a three-dimensional molded object by ejecting and laminating a plasticized material and curing the material.

For example, JP-A-2006-192710 discloses a method for creating a three-dimensional object by extruding, from an extrusion nozzle that performs scanning according to preset shape data, a thermoplastic material heated and melted by a preheater into a specific region on a base, and further laminating the melted material on a cured material on the base.

When the three-dimensional object as described above is taken out of a device in a hot state, the three-dimensional object may lose a shape thereof, or is warped or deformed due to rapid cooling, resulting in a decrease in accuracy of the three-dimensional object.

### SUMMARY

According to an aspect of the present disclosure, there is provided a three-dimensional molding device including:
an ejection unit including a plasticization unit that plasticizes a material to generate a molding material, and configured to eject the molding material from a nozzle opening;
a stage configured to support the molding material ejected from the ejection unit;
a heating unit configured to heat the molding material deposited on the stage;
a position changing unit configured to change relative positions of the ejection unit and the stage;
a housing configured to accommodate the ejection unit, the stage, the heating unit, and the position changing unit, and including a door;
a lock mechanism configured to lock and unlock the door;
a temperature detection unit configured to detect a temperature of at least one of the plasticization unit, the stage, and the heating unit; and
a control unit, in which
the control unit controls the lock mechanism based on a detection result of the temperature detection unit.

### BRIEF DESCRIPTION OF THE DRAWINGS

FIG. 1 is a perspective view schematically showing a three-dimensional molding device according to one embodiment.

FIG. 2 is a perspective view schematically showing the three-dimensional molding device according to the embodiment.

FIG. 3 is a cross-sectional view schematically showing the three-dimensional molding device according to the embodiment.

FIG. 4 is a perspective view schematically showing a flat screw of the three-dimensional molding device according to the embodiment.

FIG. 5 is a plan view schematically showing a barrel of the three-dimensional molding device according to the embodiment.

FIG. 6 is a flowchart showing processing executed by a control unit of the three-dimensional molding device according to the embodiment.

FIG. 7 is a cross-sectional view showing processing of forming molding layers by the three-dimensional molding device according to the embodiment.

### DESCRIPTION OF EXEMPLARY EMBODIMENTS

Hereinafter, a preferred embodiment of the present disclosure will be described in detail with reference to the drawings. The embodiment to be described below does not unduly limit the scope of the present disclosure described in the claims. In addition, not all configurations to be described below are necessarily essential components of the present disclosure.

### 1. Three-dimensional Molding Device

### 1.1. Overall Configuration

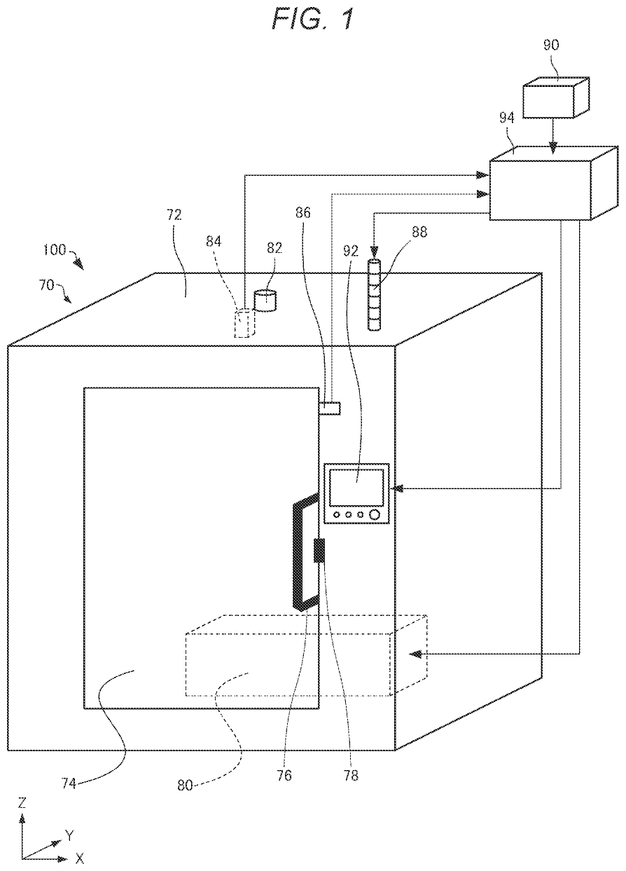

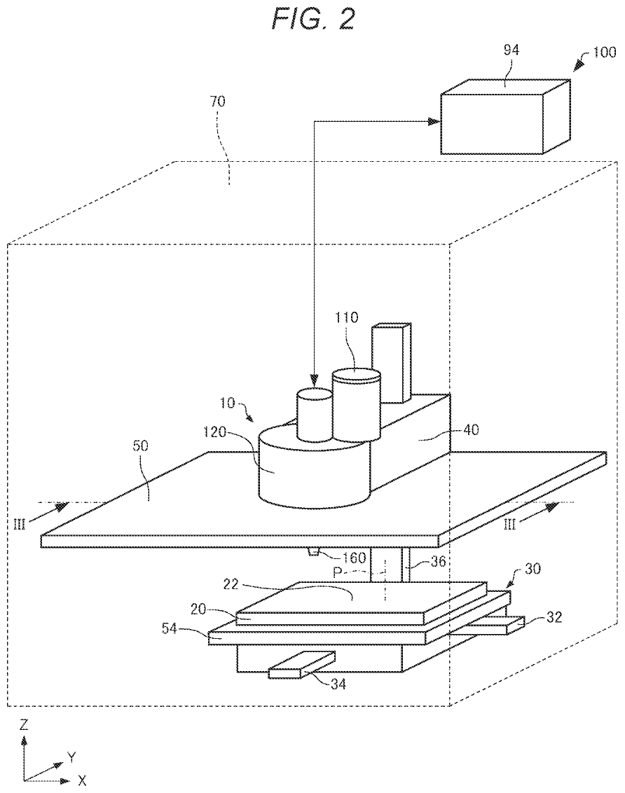

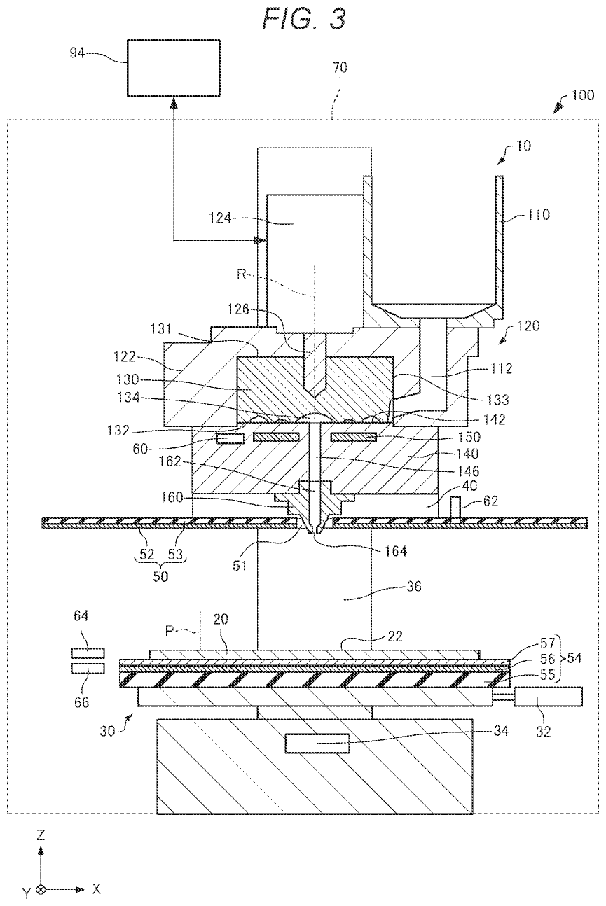

First, a three-dimensional molding device according to the embodiment will be described with reference to the drawings. FIGS. 1 and 2 are perspective views schematically showing a three-dimensional molding device 100 according to the embodiment. FIG. 3 is a cross-sectional view taken along a line III-III in FIG. 2 schematically showing the three-dimensional molding device 100 according to the embodiment.

FIGS. 1 to 3 show an X axis, a Y axis, and a Z axis as three axes orthogonal to one another. An X-axis direction and a Y-axis direction are, for example, horizontal directions. A Z-axis direction is, for example, a vertical direction.

As shown in FIGS. 1 to 3, the three-dimensional molding device 100 includes, for example, an ejection unit 10, a stage 20, a position changing unit 30, a support member 40, heating units 50, 54, temperature detection units 60, 62, 64, 66, a housing 70, a lock mechanism 78, a cooling unit 80, a discharge mechanism 82, a gas detection unit 84, an opening and closing detection unit 86, a signal tower 88, a reception unit 90, a display unit 92, and a control unit 94.

FIGS. 2 and 3 show the housing 70 in a see-through manner for convenience. FIGS. 2 and 3 do not show the lock mechanism 78, the cooling unit 80, the discharge mechanism 82, the gas detection unit 84, the opening and closing detection unit 86, the signal tower 88, the reception unit 90, and the display unit 92. FIG. 2 does not show the temperature detection units 60, 62, 64, 66.

The three-dimensional molding device 100 drives the position changing unit 30 to change relative positions of the ejection unit 10 and the stage 20 while ejecting a plasticized molding material from the ejection unit 10 toward the stage 20. Accordingly, the three-dimensional molding device 100 molds a three-dimensional molded object having a desired shape on the stage 20.

Although not shown, a plurality of ejection units 10 may be provided. For example, two ejection units 10 may be provided. In this case, both of the two ejection units 10 may eject a molding material constituting the three-dimensional molded object, or one may eject a molding material and the other may eject a support material that supports the three-dimensional molded object.

As shown in FIG. 3, the ejection unit 10 includes, for example, a material supply unit 110, a plasticization unit 120, and a nozzle 160.

A pellet-shaped material or a powdery material is put into the material supply unit 110. The material supply unit 110 supplies the material serving as a raw material to the plasticization unit 120. The material supply unit 110 is implemented by, for example, a hopper. The material supplied by the material supply unit 110 is, for example, an acrylonitrile-butadiene-styrene (ABS) resin.

The material supply unit 110 and the plasticization unit 120 are coupled by a supply path 112 provided below the material supply unit 110. The material put into the material supply unit 110 is supplied to the plasticization unit 120 via the supply path 112. In the shown example, “below” is a −Z-axis direction. “Above” is a +Z-axis direction.

The plasticization unit 120 includes, for example, a screw case 122, a drive motor 124, a flat screw 130, a barrel 140, and a heater 150. The plasticization unit 120 plasticizes at least a part of the material in a solid state supplied from the material supply unit 110, generates a paste-shaped molding material having fluidity, and supplies the molding material to the nozzle 160.

“Plasticization” is a concept including melting, and means changing from a solid state to a flowable state. Specifically, for a material in which glass transition occurs, plasticization is to set a temperature of the material to be equal to or higher than a glass transition point. For a material in which glass transition does not occur, plasticization is to set a temperature of the material to be equal to or higher than a melting point.

The screw case 122 is a housing that accommodates the flat screw 130. The barrel 140 is provided at a lower surface of the screw case 122. The flat screw 130 is accommodated in a space surrounded by the screw case 122 and the barrel 140.

The drive motor 124 is provided at an upper surface of the screw case 122. The drive motor 124 is, for example, a servomotor. A shaft 126 of the drive motor 124 is coupled to an upper surface 131 of the flat screw 130. The drive motor 124 is controlled by the control unit 94. Although not shown, the shaft 126 of the drive motor 124 and the upper surface 131 of the flat screw 130 may be coupled to each other via a speed reducer.

The flat screw 130 has a substantially cylindrical shape in which a size in a direction of a rotation axis R is smaller than a size in a direction orthogonal to the direction of the rotation axis R. In the shown example, the rotation axis R is parallel to the Z axis. The flat screw 130 is rotated about the rotation axis R by a torque generated by the drive motor 124.

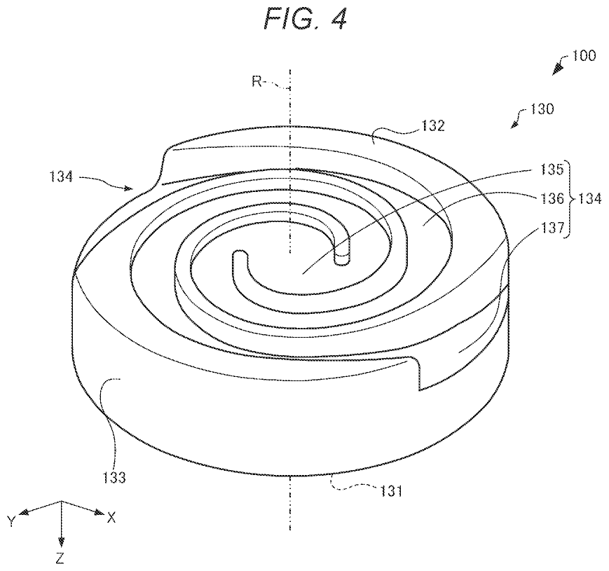

The flat screw 130 has the upper surface 131, an opposite-side groove forming surface 132 from the upper surface 131, and a side surface 133 coupling the upper surface 131 and the groove forming surface 132. First grooves 134 are formed in the groove forming surface 132. The side surface 133 is, for example, perpendicular to the groove forming surface 132. Here, FIG. 4 is a perspective view schematically showing the flat screw 130. For convenience, FIG. 4 shows a state in which an upper-lower positional relationship is opposite to a state shown in FIG. 3.

As shown in FIG. 4, the first grooves 134 are formed in the groove forming surface 132 of the flat screw 130. The first groove 134 includes, for example, a central portion 135, a coupling portion 136, and a material introduction portion 137. The central portion 135 faces a communication hole 146 formed in the barrel 140. The central portion 135 communicates with the communication hole 146. The coupling portion 136 couples the central portion 135 and the material introduction portion 137. In the shown example, the coupling portion 136 is formed in a spiral shape from the central portion 135 toward an outer periphery of the groove forming surface 132. The material introduction portion 137 is formed at the outer periphery of the groove forming surface 132. That is, the material introduction portion 137 is formed at the side surface 133 of the flat screw 130. The material supplied from the material supply unit 110 is introduced from the material introduction portion 137 into the first groove 134, passes through the coupling portion 136 and the central portion 135, and is conveyed to the communication hole 146 formed in the barrel 140. For example, two first grooves 134 are formed.

The number of first grooves 134 is not particularly limited. Although not shown, three or more first grooves 134 may be formed, or only one first groove 134 may be formed. Although not shown, the three-dimensional molding device 100 may include an in-line screw instead of the flat screw 130.

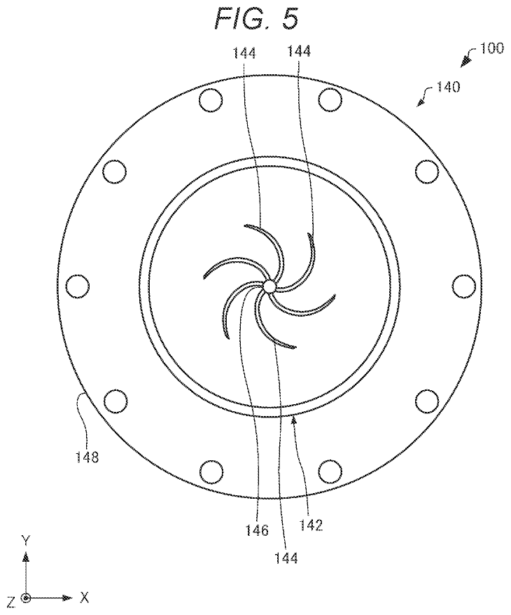

As shown in FIG. 3, the barrel 140 is provided below the flat screw 130. The barrel 140 includes a facing surface 142 facing the groove forming surface 132 of the flat screw 130. The communication hole 146 communicating with the first groove 134 is formed at a center of the facing surface 142. Here, FIG. 5 is a plan view schematically showing the barrel 140.

As shown in FIG. 5, second grooves 144 and the communication hole 146 are formed in the facing surface 142 of the barrel 140. A plurality of second grooves 144 are formed. In the shown example, six second grooves 144 are formed, but the number of second grooves 144 is not particularly limited. The plurality of second grooves 144 are formed around the communication hole 146 as viewed in the Z-axis direction. One end of the second groove 144 is coupled to the communication hole 146, and the second groove 144 extends spirally from the communication hole 146 toward an outer periphery 148 of the barrel 140. The second groove 144 has a function of guiding the plasticized molding material to the communication hole 146.

A shape of the second groove 144 is not particularly limited, and may be, for example, linear. One end of the second groove 144 may not be coupled to the communication hole 146. The second groove 144 may not be formed in the facing surface 142. However, in consideration of efficiently guiding the plasticized molding material to the communication hole 146, the second groove 144 is preferably formed in the facing surface 142.

As shown in FIG. 3, the heater 150 is provided in the barrel 140. The heater 150 heats the material supplied between the flat screw 130 and the barrel 140. The heater 150 is controlled by the control unit 94. The plasticization unit 120 generates, by the flat screw 130, the barrel 140, and the heater 150, the plasticized molding material by heating the material while conveying the material toward the communication hole 146, and flows the generated molding material out from the communication hole 146. The heater 150 may have a ring shape as viewed in the Z-axis direction.

A position of the heater 150 is not particularly limited. Although not shown, the heater 150 may be provided in, for example, the nozzle 160. The number of heaters 150 is not particularly limited. Although not shown, two heaters 150 may be provided, in which one heater 150 may be provided in the barrel 140, and the other heater 150 may be provided in the nozzle 160.

The nozzle 160 is provided below the barrel 140. A nozzle flow path 162 is formed in the nozzle 160. The nozzle flow path 162 communicates with the communication hole 146. The molding material is supplied to the nozzle flow path 162 from the communication hole 146. The nozzle flow path 162 has a nozzle opening 164. The nozzle 160 ejects the molding material from the nozzle opening 164 toward the stage 20.

As shown in FIGS. 2 and 3, the stage 20 is provided below the nozzle 160. In the shown example, the stage 20 has a rectangular parallelepiped shape. The stage 20 supports the molding material ejected from the ejection unit 10. The stage 20 includes a molding surface 22 on which the molding material is deposited. The molding surface 22 is a region of an upper surface of the stage 20. In the shown example, a perpendicular line P of the molding surface 22 is parallel to the Z axis.

A material of the stage 20 is, for example, a metal such as aluminum. The stage 20 may include a metal plate and an adhesive sheet provided at the metal plate. In this case, the molding surface 22 is formed of the adhesive sheet. The adhesive sheet can improve adhesion between the stage 20 and the molding material ejected from the ejection unit 10.

Although not shown, the stage 20 may include a metal plate in which a groove is formed, and a base layer that embeds the groove. In this case, the molding surface 22 is formed of the base layer. A material of the base layer is, for example, the same as the molding material. The base layer can improve the adhesion between the stage 20 and the molding material ejected from the ejection unit 10.

The position changing unit 30 supports the stage 20. In the shown example, the position changing unit 30 supports the stage 20 via the second heating unit 54. The position changing unit 30 changes relative positions of the nozzle 160 and the stage 20. In the shown example, the position changing unit 30 changes the relative positions of the nozzle 160 and the stage 20 in the X-axis direction and the Y-axis direction by moving the stage 20 in the X-axis direction and the Y-axis direction. Further, the position changing unit 30 changes the relative positions of the nozzle 160 and the stage 20 in the Z-axis direction by moving the ejection unit 10 in the Z-axis direction.

The position changing unit 30 includes, for example, a first electric actuator 32, a second electric actuator 34, and a third electric actuator 36. The first electric actuator 32 moves the stage 20 in the X-axis direction. The second electric actuator 34 moves the stage 20 in the Y-axis direction. The third electric actuator 36 moves the ejection unit 10 in the Z-axis direction.

A configuration of the position changing unit 30 is not particularly limited as long as the position changing unit 30 can change the relative positions of the nozzle 160 and the stage 20. For example, the position changing unit 30 may move the stage 20 in the Z-axis direction and move the ejection unit 10 in the X-axis direction and the Y-axis direction, or may move the stage 20 or the ejection unit 10 in the X-axis direction, the Y-axis direction, and the Z-axis direction.

The support member 40 is coupled to the third electric actuator 36. The support member 40 supports the ejection unit 10 and the first heating unit 50. The position changing unit 30 moves the ejection unit 10 and the first heating unit 50 in the Z-axis direction by moving the support member 40 in the Z-axis direction by the third electric actuator 36.

### 1.2. Heating Unit

The first heating unit 50 is supported by the support member 40. The first heating unit 50 moves in conjunction with the nozzle 160. The first heating unit 50 is provided higher than a position of the nozzle opening 164 during molding. As shown in FIG. 3, the first heating unit 50 has a through hole 51. The through hole 51 penetrates the first heating unit 50 in the Z-axis direction. During molding, the nozzle 160 is located in the through hole 51. “During molding” refers to time when processing of forming molding layers, which will be described later, is being executed.

The first heating unit 50 has a shape of covering at least a part of the stage 20 when the nozzle opening 164 is located at a center of the stage 20 as viewed in the Z-axis direction. When the nozzle opening 164 is located at the center of the stage 20 as viewed in the Z-axis direction, the first heating unit 50 may cover only a part of the stage 20 or the entire stage 20. The first heating unit 50 heats the molding material deposited on the stage 20.

The first heating unit 50 includes, for example, a heater 52 and a heat insulating member 53. The heater 52 faces the molding surface 22. The heater 52 is provided between the stage 20 and the heat insulating member 53. The heater 52 is, for example, a rubber heater. The heater 52 is controlled by the control unit 94. The heat insulating member 53 is provided on the heater 52. The heat insulating member 53 is coupled to the support member 40. The heat insulating member 53 can reduce heat of the heater 52 transferred upward of the heat insulating member 53.

The second heating unit 54 is supported by the position changing unit 30. The second heating unit 54 is located below the stage 20. The second heating unit 54 is provided between the position changing unit 30 and the stage 20. The second heating unit 54 moves in conjunction with the stage 20. The second heating unit 54 heats the molding material deposited on the stage 20 by heating the stage 20.

The second heating unit 54 includes, for example, a heat insulating member 55, a heater 56, and a plate 57. The heat insulating member 55 is provided between the position changing unit 30 and the heater 56. The heat insulating member 55 can reduce heat of the heater 56 transferred downward of the heat insulating member 55. The heater 56 is provided between the heat insulating member 55 and the plate 57. The heater 56 is, for example, a rubber heater. The heater 56 is controlled by the control unit 94. The plate 57 is provided between the heater 56 and the stage 20. A material of the plate 57 is, for example, aluminum.

### 1.3. Temperature Detection Unit

The first temperature detection unit 60 detects a temperature of the plasticization unit 120. The first temperature detection unit 60 detects, for example, a temperature of the heater 150 of the plasticization unit 120. In the shown example, the first temperature detection unit 60 is provided in the barrel 140.

The second temperature detection unit 62 detects a temperature of the first heating unit 50. The second temperature detection unit 62 detects, for example, a temperature of the heater 52 of the first heating unit 50. In the shown example, the second temperature detection unit 62 is supported by the heat insulating member 53.

The third temperature detection unit 64 detects a temperature of the stage 20. The third temperature detection unit 64 detects, for example, a temperature of the molding surface 22 of the stage 20. The third temperature detection unit 64 is supported by, for example, a support member (not shown).

The fourth temperature detection unit 66 detects a temperature of the second heating unit 54. The fourth temperature detection unit 66 detects, for example, a temperature of the heater 56 of the second heating unit 54. The fourth temperature detection unit 66 is supported by, for example, a support member (not shown). The temperature detection units 60, 62, 64, 66 are, for example, non-contact radiation thermometers that radiate infrared rays.

Although not shown, the three-dimensional molding device 100 may include only one of the temperature detection units 60, 62, 64, 66, only two of the temperature detection units 60, 62, 64, 66, or only three of the temperature detection units 60, 62, 64, 66.

### 1.4. Housing and the Like

The housing 70 accommodates the ejection unit 10, the stage 20, the position changing unit 30, the support member 40, the heating units 50, 54, and the temperature detection units 60, 62, 64, 66. The housing 70 has, for example, a substantially rectangular parallelepiped shape.

As shown in FIG. 1, the housing 70 includes, for example, a main body 72, a door 74, and a handle 76.

The main body 72 has a box shape. The main body 72 accommodates the ejection unit 10, the stage 20, the position changing unit 30, the support member 40, the heating units 50, 54, and the temperature detection units 60, 62, 64, 66.

The door 74 is coupled to the main body 72 via, for example, a hinge (not shown). In the shown example, the door 74 forms a surface of the housing 70 facing a −Y-axis direction. The door 74 is rotatable about a hinge. The hinge is provided at, for example, an end portion of the door 74 in a −X-axis direction.

The handle 76 is provided on the door 74. In the shown example, the handle 76 is provided at an end portion of the door 74 in a +X-axis direction. The handle 76 is gripped by a user when the door 74 is to be opened and closed.

The lock mechanism 78 is provided on the door 74. The lock mechanism 78 may be provided on the main body 72 and the door 74. The lock mechanism 78 locks and unlocks the door 74. The lock mechanism 78 can lock and unlock the door 74. For example, the lock mechanism 78 may lock and unlock the door 74 by engaging and disengaging a portion of the door 74 and a portion of the main body 72. A form of the lock mechanism 78 is not particularly limited as long as the lock mechanism 78 can lock and unlock the door 74. The user cannot open the door 74 while the lock mechanism 78 is locking the door 74. The user can open the door 74 while the lock mechanism 78 is not locking the door 74. The lock mechanism 78 is controlled by the control unit 94.

The cooling unit 80 is accommodated in, for example, the housing 70. The cooling unit 80 is provided in, for example, a +Y-axis direction of the position changing unit 30. The cooling unit 80 cools at least one of the plasticization unit 120, the stage 20, the first heating unit 50, and the second heating unit 54. Preferably, the cooling unit 80 cools all of the plasticization unit 120, the stage 20, and the heating units 50, 54. The cooling unit 80 is, for example, an electric fan or a ventilation fan. The cooling unit 80 is controlled by the control unit 94.

The discharge mechanism 82 is provided in the housing 70. In the shown example, the discharge mechanism 82 is provided at an upper surface of the housing 70. The discharge mechanism 82 discharges a gas in the housing 70 to the outside of the housing 70. The discharge mechanism 82 includes, for example, a pipe and a pump. Although not shown, the cooling unit 80 and the discharge mechanism 82 may be integrally provided.

The gas detection unit 84 is accommodated in the housing 70. The gas detection unit 84 is provided in, for example, an upper portion of the housing 70. The gas detection unit 84 detects the gas in the housing 70. The gas detection unit 84 is, for example, a sensor that detects an oxygen concentration in the housing 70.

The opening and closing detection unit 86 is provided in the housing 70. In the shown example, the opening and closing detection unit 86 is provided on the surface of the housing 70 facing the −Y-axis direction. The opening and closing detection unit 86 detects opening and closing of the door 74. A form of the opening and closing detection unit 86 is not particularly limited as long as the opening and closing detection unit 86 can detect the opening and closing of the door 74.

The signal tower 88 is provided in the housing 70. In the shown example, the signal tower 88 is provided at the upper surface of the housing 70. The signal tower 88 notifies the user of completion of molding of the three-dimensional molded object, occurrence of an error during the molding, and the like by a color of a light emitting lamp. The signal tower 88 is controlled by the control unit 94.

### 1.5. Control Unit and the Like

The reception unit 90 is provided outside the housing 70. The reception unit 90 receives an operation performed by the user. The reception unit 90 transmits a signal to the control unit 94 according to the operation performed by the user. The reception unit 90 receives an instruction to start processing to be executed by the control unit 94 from the user, and outputs a processing start signal to the control unit 94. Further, the reception unit 90 receives an instruction to unlock the door 74 from the user, and outputs an unlocking signal to the control unit 94. The reception unit 90 includes, for example, a mouse, a touch panel, and a keyboard.

The display unit 92 is provided in the housing 70. In the shown example, the display unit 92 is provided at the surface of the housing 70 facing the −Y-axis direction. The display unit 92 displays various images based on a signal from the control unit 94. The display unit 92 displays, for example, the completion of the molding of the three-dimensional molded object or the occurrence of the error during the molding. The display unit 92 includes, for example, a liquid crystal display (LCD), an organic electroluminescence (EL) display, or an electrophoretic display (EPD).

The control unit 94 is provided outside the housing 70. The control unit 94 is implemented by, for example, a computer including a processor, a main storage device, and an input and output interface that inputs a signal from the outside and outputs a signal to the outside. The control unit 94 exerts various functions by, for example, the processor executing a program read into the main storage device. Specifically, the control unit 94 controls the ejection unit 10, the position changing unit 30, the heating units 50, 54, the lock mechanism 78, the cooling unit 80, the signal tower 88, and the display unit 92. The control unit 94 may be implemented by a combination of a plurality of circuits instead of the computer.

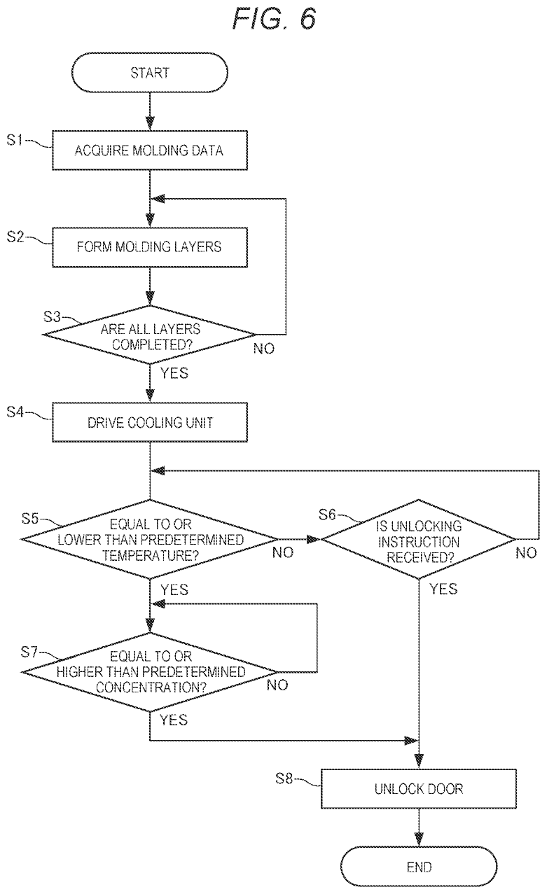

Here, FIG. 6 is a flowchart showing the processing executed by the control unit 94.

First, when receiving a processing start signal described above, the control unit 94 executes processing of acquiring molding data for molding a three-dimensional molded object in step S1.

The molding data includes information on a type of a material stored in the material supply unit 110, a movement path of the nozzle 160 with respect to the stage 20, an amount of a molding material ejected from the nozzle 160, and the like.

The molding data is created by, for example, reading shape data by slicer software installed in a computer coupled to the three-dimensional molding device 100. The shape data is data representing a target shape of the three-dimensional molded object created using three-dimensional computer aided design (CAD) software, three-dimensional computer graphics (CG) software, or the like. For example, data in a standard triangulated language (STL) format or an additive manufacturing file format (AMF) is used as the shape data. The slicer software divides the target shape of the three-dimensional molded object into layers each having a predetermined thickness, and creates molding data for each layer. The molding data is represented by a G code, an M code, or the like. The control unit 94 acquires the molding data from the computer coupled to the three-dimensional molding device 100 or a recording medium such as a universal serial bus (USB) memory.

Next, in step S2, the control unit 94 executes processing of forming molding layers by ejecting the molding material onto the stage 20.

Specifically, the control unit 94 drives the plasticization unit 120 and the heating units 50, 54 to plasticize the material supplied between the flat screw 130 and the barrel 140 to generate the molding material, and ejects the molding material from the nozzle 160. For example, the control unit 94 continuously generates the molding material until the processing of forming the molding layers is ended. In the processing of forming the molding layers, the lock mechanism 78 locks the door 74. In the processing of forming the molding layers, the cooling unit 80 is not driven.

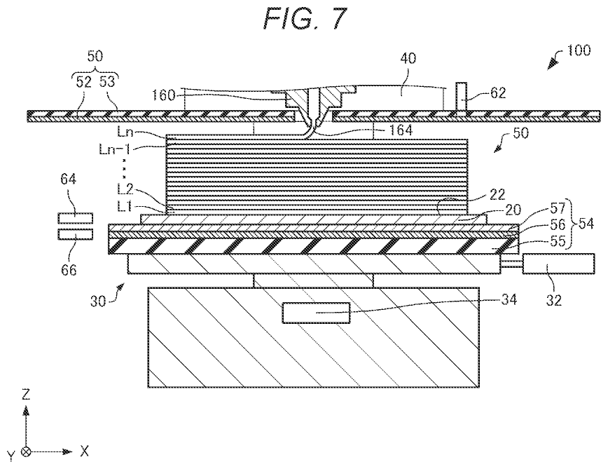

Here, FIG. 7 is a cross-sectional view showing the processing of forming the molding layers.

As shown in FIG. 7, the control unit 94 controls the ejection unit 10 to eject the molding material from the nozzle 160 toward the stage 20 while controlling the position changing unit 30 to change relative positions of the nozzle 160 and the stage 20 based on the acquired molding data.

Specifically, before the processing of forming the molding layers is started, that is, before formation of a molding layer L1 that is a first molding layer is started, the nozzle 160 is disposed at an initial position in the −X-axis direction with respect to an end portion of the stage 20 in the −X-axis direction. As shown in FIG. 7, when the processing of forming the molding layers is started, the control unit 94 controls the position changing unit 30 to move the nozzle 160 in the +X-axis direction relative to the stage 20, for example. When the nozzle 160 passes over the stage 20, the molding material is ejected from the nozzle 160. Accordingly, the molding layer L1 is formed. In FIG. 7, n is any natural number, and layers up to an n-th molding layer Ln are shown.

Next, as shown in FIG. 6, in step S3, the control unit 94 executes processing of determining whether formation of all the molding layers is completed based on the molding data.

When it is determined that the formation of all the molding layers is not completed (“NO” in step S3), the control unit 94 returns the processing to step S2. Then, the control unit 94 repeats the processing in step S2 and step S3 until it is determined in step S3 that the formation of all the molding layers is completed.

On the other hand, when it is determined that the formation of all the molding layers is completed (“YES” in step S3), in step S4, the control unit 94 executes processing of stopping supply of electric power to the ejection unit 10, the position changing unit 30, and the heating units 50, 54 and driving the cooling unit 80.

Next, the control unit 94 controls the lock mechanism 78 based on detection results of the temperature detection units 60, 62, 64, 66. Specifically, in step S5, the control unit 94 executes processing of determining whether all temperatures detected by the temperature detection units 60, 62, 64, 66 are equal to or lower than a predetermined value.

When it is determined that the temperatures detected by the temperature detection units 60, 62, 64, 66 are not equal to or lower than the predetermined value (“NO” in step S5), the control unit 94 executes processing of determining whether an unlocking signal is received from the reception unit 90 according to an unlocking instruction from the user in step S6.

When it is determined that the unlocking signal is not received (“NO” in step S6), the control unit 94 returns the processing to step S5. Then, the control unit 94 repeats the processing in step S5 and step S6 until it is determined in step S5 that all the temperatures detected by the temperature detection units 60, 62, 64, 66 are equal to or lower than the predetermined value or it is determined in step S6 that the unlocking signal is received.

When it is determined that all the temperatures detected by the temperature detection units 60, 62, 64, 66 are equal to or lower than the predetermined value (“YES” in step S5), the control unit 94 controls the lock mechanism 78 based on a detection result of the gas detection unit 84. Specifically, in step S7, the control unit 94 executes processing of determining whether an oxygen concentration detected by the gas detection unit 84 is equal to or higher than a predetermined value. It is determined in step S5 whether all the temperatures detected by the temperature detection units 60, 62, 64, 66 are equal to or lower than the predetermined value in the above example. Alternatively, it may be determined in step S5 whether at least one of the temperatures detected by the temperature detection units 60, 62, 64, 66 is equal to or lower than the predetermined value. In this case, when it is determined that at least one of the temperatures detected by the temperature detection units 60, 62, 64, 66 is equal to or lower than the predetermined value, the processing may proceed to step S7.

When it is determined that the oxygen concentration detected by the gas detection unit 84 is not equal to or higher than the predetermined value (“NO” in step S7), the control unit 94 repeats the processing in step S7 until it is determined that the oxygen concentration detected by the gas detection unit 84 is equal to or higher than the predetermined value.

On the other hand, when it is determined that the oxygen concentration detected by the gas detection unit 84 is equal to or higher than the predetermined value (“YES” in step S7), or when it is determined that the unlocking signal is received (“YES” in step S6), the control unit 94 controls the lock mechanism 78 to unlock the door 74 in step S8.

Then, the control unit 94 controls the signal tower 88 and the display unit 92 to notify the user that the processing is ended, and then ends the processing. In the flowchart described above, the processing in step S7 may be omitted.

### 1.6. Operational Effects

The three-dimensional molding device 100 includes the housing 70 that accommodates the ejection unit 10, the stage 20, the heating units 50, 54, and the position changing unit 30 and that includes the door 74, the lock mechanism 78 that locks and unlocks the door 74, the temperature detection units 60, 62, 64, 66 that detect temperatures of the plasticization unit 120, the stage 20, and the heating units 50, 54, and the control unit 94. The control unit 94 controls the lock mechanism 78 based on the detection results of the temperature detection units 60, 62, 64, 66.

Therefore, in the three-dimensional molding device 100, even when the molding of the three-dimensional molded object is completed, the door 74 is not immediately opened by the user. Accordingly, the three-dimensional molded object is taken out in a state in which a temperature of the three-dimensional molded object is lowered to a predetermined value. Therefore, it is possible to reduce a chance that the three-dimensional molded object loses a shape thereof or that the three-dimensional molded object is warped or deformed due to rapid cooling. As a result, accuracy of the three-dimensional molded object can be improved.

In the embodiment described above, the control unit 94 controls the lock mechanism 78 based on the detection results of the temperature detection units 60, 62, 64, 66 that detect the temperatures of the plasticization unit 120, the stage 20, and the heating units 50, 54. Alternatively, the three-dimensional molding device 100 may include a temperature detection unit that measures a surface temperature of the three-dimensional molded object, and the control unit 94 may control the lock mechanism 78 based on the surface temperature of the three-dimensional molded object measured by the temperature detection unit. However, it is preferable to control the lock mechanism 78 based on the detection results of the temperature detection units 60, 62, 64, 66 that detect the temperatures of the plasticization unit 120, the stage 20, and the heating units 50, 54. This is because a temperature up to the inside of the three-dimensional molded object can be lowered as compared to a case in which a surface of the three-dimensional molded object is measured by the temperature detection unit and the lock mechanism is controlled based on a detection result of the temperature detection unit, for example. Then, depending on the shape and material of the three-dimensional molded object, even when the temperature of the surface is lowered to a predetermined value, the temperature of the inside may not be lowered to the predetermined value, and it is possible to reduce a chance of such a problem.

The three-dimensional molding device 100 includes the gas detection unit 84 that detects the gas in the housing 70, and the control unit 94 controls the lock mechanism 78 based on the detection result of the gas detection unit 84. Therefore, in the three-dimensional molding device 100, for example, it is possible to prevent the door 74 from being opened while the oxygen concentration in the housing 70 is low.

The three-dimensional molding device 100 includes the discharge mechanism 82 that discharges the gas in the housing 70 to the outside of the housing 70. Therefore, in the three-dimensional molding device 100, it is possible to prevent the housing 70 from being filled with a predetermined gas.

The three-dimensional molding device 100 includes the cooling unit 80 that cools at least one of the plasticization unit 120, the stage 20, and the heating units 50, 54. Therefore, in the three-dimensional molding device 100, the temperature of at least one of the plasticization unit 120, the stage 20, and the heating units 50, 54 can be lowered by the cooling unit 80.

The three-dimensional molding device 100 includes the first heating unit 50 located higher than the nozzle opening 164 during molding and having the shape of covering at least a part of the stage 20 when the nozzle opening 164 is located at the center of the stage 20, and the first heating unit 50 moves in conjunction with the ejection unit 10. Therefore, in the three-dimensional molding device 100, it is possible to improve adhesion between the first molding layer formed on the stage 20 and a second molding layer formed on the first molding layer.

The three-dimensional molding device 100 includes the second heating unit 54 that is located below the stage 20 and that heats the stage 20. Therefore, in the three-dimensional molding device 100, it is possible to improve the adhesion between the first molding layer formed on the stage 20 and the second molding layer formed on the first molding layer.

The three-dimensional molding device 100 includes the reception unit 90 that receives the instruction to unlock the door 74 from the user, and when the reception unit 90 receives the instruction, the control unit 94 controls the lock mechanism 78 to unlock the door 74 based on the instruction instead of the detection results of the temperature detection units 60, 62, 64, 66. Therefore, in the three-dimensional molding device 100, when the user desires to open the door 74, the door 74 can be opened without control of the control unit 94.

In the above description, an example has been described in which the processing of determining whether the unlocking signal is received from the reception unit 90 is executed after the processing of forming the molding layers. Alternatively, the determination processing may be executed during the processing of forming the molding layers. When it is determined that the unlocking signal is received during the processing of forming the molding layers, the control unit 94 controls the lock mechanism 78 to unlock the door 74 even during the processing of forming the molding layers. When the user opens the door 74 and the opening and closing detection unit 86 detects opening of the door 74, the control unit 94 stops supply of electric power to at least one of the ejection unit 10, the position changing unit 30, the first heating unit 50, and the second heating unit 54. Preferably, the control unit 94 stops supply of electric power to all of the ejection unit 10, the position changing unit 30, and the heating units 50, 54. Accordingly, safety of the user can be improved. After stopping the supply of electric power, the control unit 94 ends the processing.

### 2. Modification of Three-dimensional Molding Device

Next, a three-dimensional molding device according to a modification of the embodiment will be described.

Hereinafter, in the three-dimensional molding device according to the modification of the embodiment, differences from the three-dimensional molding device 100 according to the embodiment described above will be described, and the description of the same points will be omitted.

In the three-dimensional molding device 100 described above, the material supplied from the material supply unit 110 is the ABS resin.

However, in the three-dimensional molding device according to the modification of the embodiment, a material supplied from the material supply unit 110 is a material other than the ABS resin, or a material obtained by adding other components to the ABS resin.

Examples of the material supplied from the material supply unit 110 include a thermoplastic material, a metal material, and a material made of various materials such as a ceramic material as a main material. Here, the “main material” means a material serving as a center forming a shape of a three-dimensional molded object, and means a material occupying 50% by mass or more in the three-dimensional molded object. The materials described above include a material obtained by melting the main material alone, and a material obtained by melting a part of components contained together with the main material into a paste form.

For example, a thermoplastic resin may be used as the thermoplastic material. Examples of the thermoplastic resin include a general-purpose engineering plastic and a super engineering plastic.

Examples of the general-purpose engineering plastic include polypropylene (PP), polyethylene (PE), polyacetal (POM), polyvinyl chloride (PVC), polyamide (PA), polylactic acid (PLA), polyphenylene sulfide (PPS), polycarbonate (PC), modified polyphenylene ether, polybutylene terephthalate, and polyethylene terephthalate.

Examples of the super engineering plastic include polysulfone (PSU), polyether sulfone (PES), polyphenylene sulfide (PPS), polyarylate (PAR), polyimide (PI), polyamideimide (PAI), polyetherimide (PEI), and polyether ether ketone (PEEK).

A pigment, a metal, a ceramic, and other additives such as a wax, a flame retardant, an antioxidant, and a thermal stabilizer may be mixed into the thermoplastic material.

In the plasticization unit 120, the thermoplastic material is plasticized and converted into a molten state by rotation of the flat screw 130 and heating of the heater 150. The molding material generated in this manner is deposited from the nozzle 160 and then cured by a decrease in temperature. It is desirable that the thermoplastic material is ejected from the nozzle 160 while being heated to a temperature equal to or higher than a glass transition point thereof and completely melted.

In the plasticization unit 120, for example, a metal material may be used as a main material instead of the thermoplastic material described above. In this case, it is desirable that a powder material obtained by powdering the metal material is mixed with a component that is melted during generation of the molding material, and the mixture is put into the plasticization unit 120.

Examples of the metal material include a single metal such as magnesium (Mg), iron (Fe), cobalt (Co), chromium (Cr), aluminum (Al), titanium (Ti), copper (Cu), and nickel (Ni), or an alloy containing one or more of these metals, maraging steel, stainless steel, cobalt chromium molybdenum, a titanium alloy, a nickel alloy, an aluminum alloy, a cobalt alloy, and a cobalt chromium alloy.

In the plasticization unit 120, a ceramic material can be used as a main material instead of the metal material described above. Examples of the ceramic material include oxide ceramics such as silicon dioxide, titanium dioxide, aluminum oxide, and zirconium oxide, and non-oxide ceramics such as aluminum nitride.

A powder material made of the metal material or the ceramic material supplied from the material supply unit 110 may be a mixed material obtained by mixing a plurality of types of powder of a single metal, powder of an alloy, or powder of a ceramic material. The powder material made of the metal material or the ceramic material may be coated with, for example, the thermoplastic resin described above or other thermoplastic resins. In this case, in the plasticization unit 120, the thermoplastic resin may be melted to exhibit fluidity.

For example, a solvent may be added to the powder material made of the metal material or the ceramic material supplied from the material supply unit 110. Examples of the solvent include: water; (poly) alkylene glycol monoalkyl ethers such as ethylene glycol monomethyl ether, ethylene glycol monoethyl ether, propylene glycol monomethyl ether, and propylene glycol monoethyl ether; acetic acid esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; alcohols such as ethanol, propanol, and butanol; tetraalkylammonium acetates; sulfoxide-based solvents such as dimethyl sulfoxide and diethyl sulfoxide; pyridine-based solvents such as pyridine, γ-picoline, and 2,6-lutidine; tetraalkylammonium acetate (for example, tetrabutylammonium acetate); and ionic liquids such as butyl carbitol acetate.

In addition, for example, a binder may be added to the powder material made of the metal material or the ceramic material supplied from the material supply unit 110. Examples of the binder include an acrylic resin, an epoxy resin, a silicone resin, a cellulose-based resin, other synthetic resins, PLA, PA, PPS, PEEK, and other thermoplastic resins.

The embodiment and modification described above are merely examples, and the present disclosure is not limited thereto. For example, the embodiment and modification may be combined as appropriate.

The present disclosure includes a configuration substantially the same as the configuration described in the embodiment, for example, a configuration having the same function, method, and result, or a configuration having the same object and effect. In addition, the present disclosure includes a configuration obtained by replacing a nonessential portion of the configuration described in the embodiment. In addition, the present disclosure includes a configuration having the same function and effect as the configuration described in the embodiment, or a configuration capable of achieving the same object. In addition, the present disclosure includes a configuration in which a known technique is added to the configuration described in the embodiment.

The following contents are derived from the embodiment and modification described above.

A three-dimensional molding device according to an aspect includes:
an ejection unit including a plasticization unit that plasticizes a material to generate a molding material, and configured to eject the molding material from a nozzle opening;
a stage configured to support the molding material ejected from the ejection unit;
a heating unit configured to heat the molding material deposited on the stage;
a position changing unit configured to change relative positions of the ejection unit and the stage;
a housing configured to accommodate the ejection unit, the stage, the heating unit, and the position changing unit, and including a door;
a lock mechanism configured to lock and unlock the door;
a temperature detection unit configured to detect a temperature of at least one of the plasticization unit, the stage, and the heating unit; and
a control unit, in which
the control unit controls the lock mechanism based on a detection result of the temperature detection unit.

According to the three-dimensional molding device, it is possible to improve accuracy of a three-dimensional molded object.

The three-dimensional molding device according to the aspect may further include
a gas detection unit configured to detect a gas in the housing, in which
the control unit may control the lock mechanism based on a detection result of the gas detection unit.

According to the three-dimensional molding device, for example, it is possible to prevent the door from being opened while an oxygen concentration in the housing is low.

The three-dimensional molding device according to the aspect may further include
a discharge mechanism configured to discharge the gas in the housing to outside of the housing.

According to the three-dimensional molding device, it is possible to prevent the housing from being filled with a predetermined gas.

The three-dimensional molding device according to the aspect may further include
a cooling unit configured to cool at least one of the plasticization unit, the stage, and the heating unit.

According to the three-dimensional molding device, the temperature of at least one of the plasticization unit, the stage, and the heating unit can be lowered by the cooling unit.

In the three-dimensional molding device according to the aspect,
the heating unit may include a first heating unit located higher than the nozzle opening during molding and having a shape of covering at least a part of the stage when the nozzle opening is located at a center of the stage, and
the first heating unit may move in conjunction with the ejection unit.

According to the three-dimensional molding device, it is possible to improve adhesion between a first molding layer formed on the stage and a second molding layer formed on the first molding layer.

In the three-dimensional molding device according to the aspect,
the heating unit may include a second heating unit located below the stage and configured to heat the stage.

According to the three-dimensional molding device, it is possible to improve the adhesion between the first molding layer formed on the stage and the second molding layer formed on the first molding layer.

The three-dimensional molding device according to the aspect may further include
a reception unit configured to receive an instruction to unlock the door from a user, in which
when the instruction is received by the reception unit, the control unit may unlock the lock mechanism based on the instruction instead of the detection result of the temperature detection unit.

According to the three-dimensional molding device, when the user desires to open the door, the door can be opened without control of the control unit.

The three-dimensional molding device according to the aspect may further include
an opening and closing detection unit configured to detect opening and closing of the door, in which
when the opening and closing detection unit detects opening of the door, the control unit stops supply of electric power to at least one of the ejection unit, the heating unit, and the position changing unit.

According to the three-dimensional molding device, safety of the user can be improved.

What is claimed is:

1. A three-dimensional molding device comprising:
an ejection unit including a plasticization unit that plasticizes a material to generate a molding material, and configured to eject the molding material from a nozzle opening;
a stage configured to support the molding material ejected from the ejection unit;
a heating unit configured to heat the molding material deposited on the stage;
a position changing unit configured to change relative positions of the ejection unit and the stage;
a housing configured to accommodate the ejection unit, the stage, the heating unit, and the position changing unit, and including a door;
a lock mechanism configured to lock and unlock the door;
a temperature detection unit configured to detect a temperature of at least one of the plasticization unit, the stage, and the heating unit; and
a control unit, wherein
the control unit controls the lock mechanism based on a detection result of the temperature detection unit.

2. The three-dimensional molding device according to claim 1, further comprising:
a gas detection unit configured to detect a gas in the housing, wherein
the control unit controls the lock mechanism based on a detection result of the gas detection unit.

3. The three-dimensional molding device according to claim 1, further comprising:
a discharge mechanism configured to discharge the gas in the housing to outside of the housing.

4. The three-dimensional molding device according to claim 1, further comprising:
a cooling unit configured to cool at least one of the plasticization unit, the stage, and the heating unit.

5. The three-dimensional molding device according to claim 1, wherein
the heating unit includes a first heating unit located higher than the nozzle opening during molding and having a shape of covering at least a part of the stage when the nozzle opening is located at a center of the stage, and
the first heating unit moves in conjunction with the ejection unit.

6. The three-dimensional molding device according to claim 1, wherein
the heating unit includes a second heating unit located below the stage and configured to heat the stage.

7. The three-dimensional molding device according to claim 1, further comprising:
a reception unit configured to receive an instruction to unlock the door from a user, wherein
when the instruction is received by the reception unit, the control unit unlocks the lock mechanism based on the instruction instead of the detection result of the temperature detection unit.

8. The three-dimensional molding device according to claim 1, further comprising:
an opening and closing detection unit configured to detect opening and closing of the door, wherein
when the opening and closing detection unit detects opening of the door, the control unit stops supply of electric power to at least one of the ejection unit, the heating unit, and the position changing unit.
